(19) United States
(12) Patent Application Publication
(10) Pub. No.: US 2014/0196054 A1
(43) Pub. Date: Jul. 10, 2014

(54) ENSURING PERFORMANCE OF A COMPUTING SYSTEM

(71) Applicant: INTERNATIONAL BUSINESS MACHINES CORPORATION, Armonk, NY (US)

(72) Inventors: Luigi Brochard, Paris (FR); Rajendra D. Panda, Austin, TX (US); Francois Thomas, Alencon (FR)

(73) Assignee: INTERNATIONAL BUSINESS MACHINES CORPORATION, Armonk, NY (US)

(21) Appl. No.: 13/734,090

(22) Filed: Jan. 4, 2013

(51) Int. Cl. G06F 9/50

(52) U.S. Cl. CPC G06F 9/5083
USPC 718/105

(57) ABSTRACT

A system includes a plurality of computing systems, wherein each computing system comprises memory, a network interface and a processor. At least one computing system is configured to issue a command to run abbreviated measurements of performance for one or more computing nodes to determine whether a number of the computing nodes is adequate to perform a computing job. The at least one computing system is configured to assign the computing job to a set of the number of computing nodes if each of the set of the number of computing nodes is adequate to perform the computing job according to performance measurement results of the abbreviated measurements. For any of the one or more computing nodes that is inadequate to perform the computing job according to performance measurement results of the abbreviated measurements, the at least one computing system is configured to indicate those computing nodes as low performing.

### BACKGROUND

Embodiments of the inventive subject matter generally relate to the fields of high performance and cloud computing and, more particularly, to ensuring the performance of a computing system.

In the area of high performance computing, applications are designed to be run on large clusters of computers. Clusters can contain thousands of individual computing systems, known as nodes. The applications that use these clusters are designed to run many “jobs” in parallel, so that each node can run a job individually. The application runs multiple sets of jobs, and between each set may combine the results from the completed jobs before generating the next set of jobs. Because each job in a set of jobs can be dependent on the other jobs, one slow node can cause all other nodes to sit idle while the slow node finishes the job assigned to it. Thus, ensuring equal performance of all nodes is an important consideration for high performance computing clusters.

The configuration and expected performance of nodes within a cluster is typically known. In the area of cloud computing, on the other hand, it may not be possible to know the configuration or performance of a particular node. For example, in many cloud computing systems, the individual nodes are virtual servers. Although these virtual servers may be described as having a certain configuration, multiple virtual servers may be hosted on a single computing system. The other virtual servers hosted on the same computing system may be used by another entity, making it difficult to determine what resources of the underlying computing system are being used. Thus, if one virtual server is hosted on a computing system with no other active virtual servers, the performance may be higher than a virtual server hosted on a computing system that also hosts multiple other active virtual servers, even if both virtual servers have identical specifications.

### SUMMARY

Embodiments of the inventive subject matter generally include a method comprising issuing a command to run abbreviated measurements of performance for one or more computing nodes to determine whether a number of the one or more computing nodes is adequate to perform a computing job. A request for the computing job indicates the number of the one or more computing nodes. The computing job is assigned to a set of the number of computing nodes if each of the set of the number of computing nodes is adequate to perform the computing job according to performance measurement results of the abbreviated measurements. For any of the one or more computing nodes that is inadequate to perform the computing job according to performance measurement results of the abbreviated measurements, those computing nodes are indicated as low performing.

### BRIEF DESCRIPTION OF THE DRAWINGS

The present embodiments may be better understood, and numerous objects, features, and advantages made apparent to those skilled in the art by referencing the accompanying drawings.

FIG. 1 depicts the interactions between a performance measuring job scheduler and a high performance computing cluster to ensure node performance.

FIG. 2 depicts a flowchart of example operations to ensure the performance of nodes in a cluster.

FIG. 3 depicts the interactions between components of a cloud computing environment to provision a virtual server with adequate performance.

FIG. 4 depicts a flowchart of example operations to ensure the performance of a server in a cloud computing environment.

FIG. 5 depicts an example computing system with a pre-job performance measuring job scheduler.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to high performance computing clusters and cloud computing, the inventive subject matter applies to other areas in which ensuring the performance of a computing system prior to, or during, use is important. In other instances, well-known instruction instances, protocols, structures and techniques have not been shown in detail in order not to obfuscate the description.

A high performance computing cluster (hereinafter “cluster”) designed for running parallel applications can consist of thousands of homogenous nodes, or individual computing systems. In a homogenous cluster, each node will have the same configuration, including the same number of processors running at the same clock rate, the same number and speed memory modules, etc. The goal of a homogenous cluster is to ensure that each node runs with similar performance to each other, within a fairly small margin of error.

An application designed to run within a parallel computing environment is designed to generate many individual units of computing tasks, or “jobs,” that when completed, can be combined to produce a result(s). For example, an application can run a set of jobs on a cluster, and using the results from the first set of jobs, generate a second set of jobs. This can continue for many hours, with each set of jobs potentially lasting an hour or longer.

In these scenarios, the performance of a single node can have an impact on the performance of the entire cluster. For example, one misconfigured node may have a single memory module with a slower speed than the other nodes. This misconfiguration could potentially cause a performance decrease. Assuming a performance decrease of ten percent, an application that takes twenty four hours to run takes more than twenty six hours. This occurs because the application waits for all nodes to finish before combining the results of the jobs. Additionally, not only does the entire process take longer, but the nodes that perform as expected, or meet criteria established by the job scheduler or requesting application (hereinafter “adequate nodes”), sit idle while the job on the low performing node finishes.

A job scheduler controls the jobs on the cluster. Applications do not have to use all cluster nodes at once, but may use only a subset of the total number of nodes. The job scheduler includes an indication(s) of applications that are waiting to perform jobs. The applications provide information describing the number of nodes desired, the level of performance or node configurations desired, etc. As subsets of nodes become available that meet the applications' specifications, the job scheduler assigns the nodes to the applications.

The cluster performance is tested during the initial setup of the cluster. In certain scenarios, such as when an application takes longer to complete than expected, the cluster performance may be tested again. A post hoc performance measurement of a cluster's performance only helps future applications. Measuring performance of the nodes in a cluster can take a significant amount of time, thus limiting regular performance measurements.

A job scheduler can be designed to measure node performance before being assigned to an application for use. Thus, the job scheduler can identify nodes with low performance, marking them as unavailable and selecting another node with adequate performance to take its place. To facilitate the job scheduler in measuring node performance prior to each set of nodes being assigned to an application, the job scheduler can use abbreviated performance measurements that take a small amount of time to run relative to the time for unabbreviated performance measurements. By allowing the job scheduler to automatically run quick, accurate performance measurements prior to assigning a set of nodes to an application, the job scheduler prevents a low performing node from slowing down the entire set of jobs. Furthermore, by using abbreviated performance measurements, the performance measurements can be run before every node is assigned without significantly delaying the scheduling of jobs.

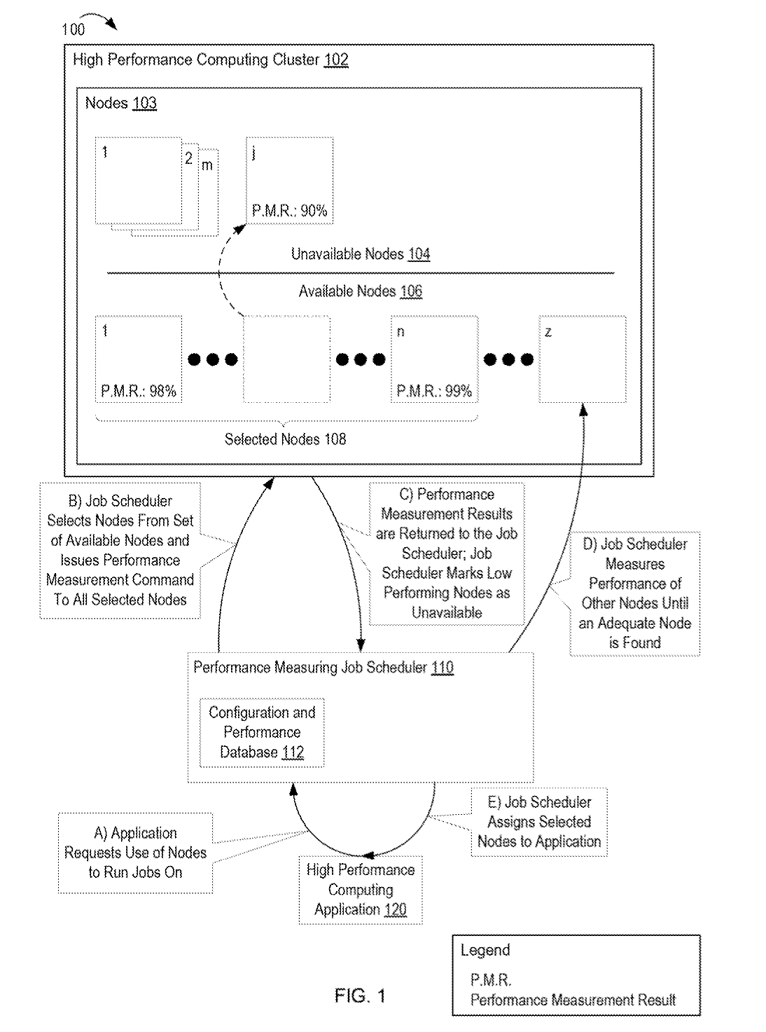

FIG. 1 depicts the interactions between a performance measuring job scheduler and a high performance computing cluster to ensure node performance. FIG. 1 depicts a high performance computing system 100, including a high performance computing cluster (cluster) 102, performance measuring job scheduler (job scheduler) 110, and high performance computing application (application) 120. The job scheduler 110 includes a configuration and performance database (configuration database) 112. The cluster 102 initially includes a set of nodes 103, which includes a set of m unavailable nodes 104, a set of z available nodes 106, and a set of n selected nodes 108. The set of selected nodes 108 is a subset of the available nodes 106. The cluster 102 is assumed to contain only homogenous nodes.

At stage A, the application 120 sends a request for the use of the cluster 102 to the job scheduler 110. The information included in the request can vary based on the implementation. For example, the application 120 can specify the minimum or maximum number of nodes 103 to run the jobs. For clusters with a heterogeneous set of nodes 103, the application 120 can specify a node configuration(s), node type, or performance criteria. In this example, it is assumed that the application 120 requests the use of n available nodes 106. The job scheduler 110 receives the request and, if there is an insufficient number of available nodes 106, makes an indication that the application is waiting for available nodes. If there is a sufficient number of available nodes 106, or a sufficient number of available nodes 106 become available, the job scheduler 110 proceeds.

At stage B, the job scheduler 110 selects a number of available nodes 106 from the set of available nodes 106 to service the application 120 request. In this example, there are z available nodes 106, and the application requested n. Thus, the job scheduler 110 begins by selecting n available nodes 106. The job scheduler 110 then issues a command to begin measuring performance to all selected nodes 108.

Each node in the set of nodes 103 has performance measuring software designed to test the performance of each node in the set of nodes 103. For example, the performance measuring software can include programs designed to test memory performance, input/output latency, and integer calculation performance. The performance measuring software is chosen or designed such that it finishes in a short amount of time. For example, some performance measuring software may take longer than an hour to run, while only testing individual aspects of computing system performance. Abbreviated performance measuring software, on the other hand, can complete in seconds or minutes while still providing accurate measurement of performance. Using abbreviated performance measuring software to generate performance measurement results allows for multiple aspects of each node in the set of nodes 103 to be tested in seconds or minutes.

In some embodiments, the job scheduler 110 can instruct a node in the set of nodes 103 to run a subset of the performance measuring software. For example, the application 120 can notify the job scheduler 110 of what performance criteria are important for the jobs run by the application 120. If the application 120 frequently accesses memory, the job scheduler 110 can issue a command to run only software to measure memory bandwidth and avoid running performance measuring software that tests the integer performance of the processor. This reduces the amount of time spent running performance measuring software while ensuring adequate performance for the specific application 120.

At stage C, the performance measurement results generated by the performance measuring software are returned to the job scheduler 110. To determine which performance measurement results signify a low performing node, the job scheduler 110 has a configuration database 112. The configuration database 112 includes information detailing the configuration of each node in the set of nodes 103, as well as benchmarks for various node configurations. When the job scheduler 110 receives the performance measurement results from the nodes 103, the job scheduler 110 looks up the configuration in the configuration database 112 for each node that returned performance measurement results. The job scheduler 110 also looks up the benchmarks for each node configuration in the configuration database 112. The job scheduler 110 compares the performance measurement results for each node in the set of nodes 103 to the benchmarks for the node configuration. If one of the performance measurement results for a node is below a certain threshold relative to the benchmark, the node is marked as low performing. For example, a low performing node could be defined as any node that has at least one performance measurement result lower than ninety-three percent of the associated benchmark. If a particular node performance measurement result was ninety percent of the benchmark, it would be marked as low performing. The threshold at which a node is marked as low performing, such as ninety-three percent in the previous example, is the low performing node threshold.

In some embodiments, the application 120 can prioritize performance criteria indicated in a job request and/or indicate preferences for performance criteria. For example, an application submits a request that specifies performance criteria that nodes must operate at least at 1.8 Ghz with a memory latency of no more than 8 milliseconds. The request also indicates a preference for nodes operating at 2.0 Ghz with a latency of no more than 5 milliseconds, and indicates priority for the memory latency performance criterion. When selecting nodes, the job scheduler would choose a node capable of operating at 1.8 Ghz and having a memory latency of 5 milliseconds over a node capable of operating at 2.0 Ghz and having a memory latency of 7 milliseconds based on the indicated performance criteria preferences and priority. The preferred performance criteria for the nodes 103 provided by the application 120 to the job scheduler 110 can be indicated with a list of performance measurements to take for the available nodes 106. The job scheduler 110 compares the performance measurement results with predetermined benchmark values to determine whether the available nodes 106 meet the preferred performance criteria. If the certain performance criteria are given lower priority, the job scheduler 110 can allow nodes with a greater deviation from the benchmark for the lower priority performance criteria. The list can also include specific low performing node thresholds for the various performance measurement results. For example, the list could include the low performing node threshold for a memory bandwidth benchmark as ninety-four percent of the benchmark. The list could also include the low performing node threshold for an integer performance benchmark as eighty-five percent of the benchmark. The list could also include the benchmark itself, along with the allowable deviation. Thus, the application 120 can identify the benchmark for a particular performance measurement result instead of relying on a benchmark determined by the job scheduler 110.

In some embodiments, the job scheduler 110 or the performance testing software can generate a dynamic score reflecting the performance of a node based on the performance measurement results. The score can be further based on input from the application 120. For example, as discussed above, the application 120 can communicate the desired performance criteria for a node to the job scheduler 110 in the form of a list of performance measurement software. The list can also include weights with the performance measurement software, with each weight indicating the relative importance of a particular performance measurement result. For example, the list can include performance measurement software for testing memory bandwidth with a weight of ninety, and a benchmark for integer performance with a weight of ten. The performance testing software for memory bandwidth and integer performance would be run on each node. The resulting performance measurement results would be multiplied by their respective weights and added together to generate a score for each node. The job scheduler 110 would then determine whether a node is low performing by comparing the generated score with a minimum score provided by the application 120.

Any node marked as low performing would be considered unavailable. In this example, the threshold for marking a node low performing is at least ninety-eight percent of the benchmark. Thus, all selected nodes 108 meet this threshold except for node j, which has a performance measurement result that is ninety percent of the benchmark. Thus, the job scheduler 110 marks it as low performing and unavailable.

At stage D, the job scheduler 110 measures the performance of other available nodes 106 that were not initially selected nodes 108. After marking node j as unavailable at stage C, the job scheduler 110 no longer had n nodes to assign to the application 120. Thus, the job scheduler 110 selects another node from the set of available nodes 106, such as node z, and issues the commands to run the appropriate performance measuring software. This process is repeated until a replacement node from the set of available nodes 106 that have not already been selected is found. In scenarios where the application 120 requests n nodes and only n nodes are available, the job scheduler 110 can take other courses of action based on client specifications, policies, etc. For example, the job scheduler 110 can wait until another node from the set of unavailable nodes 103 becomes available. Or the job scheduler 110 can determine from specifications or communications to a client whether a limited number of nodes (e.g., one node) with slightly lower performance results can be selected.

In some embodiments, if there are z available nodes 106 and the application 110 only requests n available nodes, as in this example, the job scheduler 110 issues commands to run the performance measuring software to all available nodes 106. This allows the job scheduler 110 to select adequate nodes from all of the available nodes 106. By measuring the performance of all available nodes 106, the job scheduler does not wait while testing additional nodes if a low performing node is found.

At stage E, the job scheduler 110 has a set of selected nodes that are verified to be adequate. The job scheduler 110 assigns these selected nodes to the application 120. The application 120 can then begin running jobs on each of the assigned nodes under conditions in which the application is not slowed by an individual node.

It is possible for a node to become a low performing node while assigned to the application 120. This can happen for various reasons, such as a memory module going bad or a process not properly finishing. Thus, if a set of jobs would normally take twenty-four hours to complete, and the performance of a single node drops by ten percent halfway through, the entire set of jobs could take an extra hour. An embodiment that performs the performance measurement before the selected nodes 108 are assigned to the application 120 only ensures the performance of the assigned nodes from that point forward and does not ensure performance throughout the set of jobs. But the use of an abbreviated set of performance measurements that finish in minutes allows some embodiments to perform the measurements more regularly. Thus, the job scheduler 110 can be designed to run the performance measurements in response to any combination of definable events. For example, the completion of a job or the passage of a certain length of time may be defined as events that trigger a performance measurement. The job scheduler 110 can be designed such that different combinations of, or multiple, events trigger a performance measurement. For example, the job scheduler 110 could be designed to run performance measurements every thirty minutes or between jobs, whichever is longer. Or, if all nodes 103 assigned to the application 120 are idle for a certain length of time except for one, the job scheduler 110 can run the performance measurements when the last node finishes the current job to check if the non-idle node has become a low performing node. In the event that the job scheduler 110 determines that an assigned node has become low performing, the job scheduler 110 can assign a new node to the application 120 as described above.

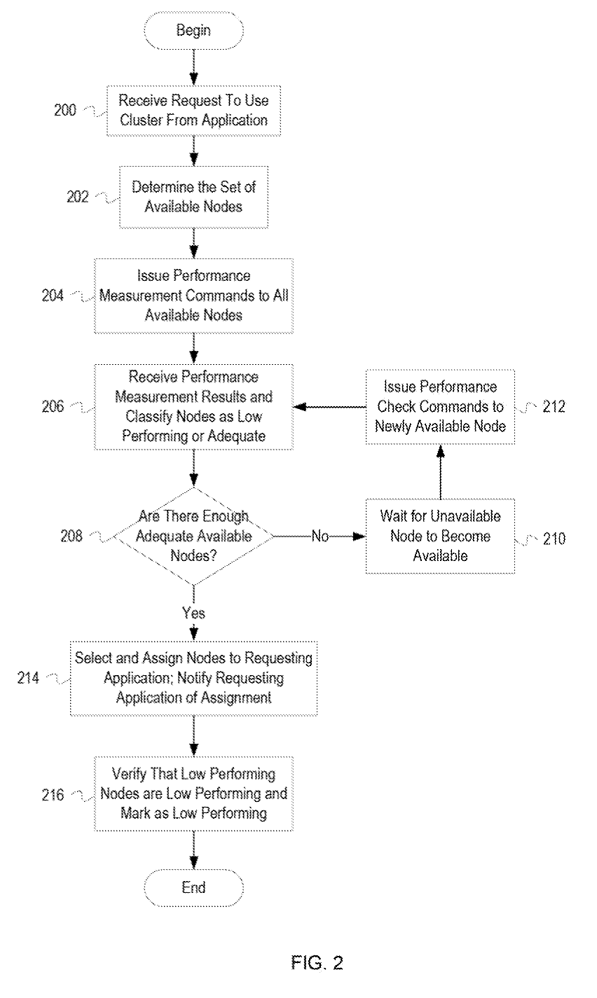

FIG. 2 depicts a flowchart of example operations to ensure the performance of nodes in a cluster. As an example flowchart, FIG. 2 presents operations in an example order from which embodiments can deviate (e.g., operations can be performed in a different order than illustrated and/or in parallel). Control is discussed in reference to the job scheduler.

At block 200, the job scheduler receives a request to use the cluster from an application. The request can include information such as how many nodes are requested and the performance criteria for the nodes that are important to the performance of the application. Control then flows to block 202.

At block 202, the job scheduler determines the set of available nodes. Within a cluster, a subset of nodes may be assigned to other applications. Other nodes may be marked as unavailable for other reasons, such as having previously been found to be low performing or being offline for maintenance. The job scheduler can store state information related to the cluster, such as which nodes are available, and determine the set of available nodes based on that information. The job scheduler can also query other software or hardware components of the cluster to determine the set of available nodes. In clusters that consist of heterogeneous nodes, the job scheduler can use information provided in the request to exclude nodes that are not appropriate for the requesting application. After determining the set of available nodes, control then flows to block 204.

At block 204, the job scheduler issues performance measurement commands to all nodes in the set of available nodes. Each node runs the performance measuring software upon receiving a command to do so from the job scheduler. If multiple performance measuring software programs are installed on the nodes, the job scheduler can issue a set of commands to run a subset of the performance measuring software installed on the nodes. The job scheduler can also issue a single command that specifies the individual performance measuring software programs to run. The set of performance measuring software is installed on each node. Control then flows to block 206.

At block 206, the job scheduler receives the performance measurement results from all of the nodes. Upon receiving performance measurement results, the job scheduler classifies the available nodes into two categories: adequate and low performing. The job scheduler determines the classification based on the performance measurement results. To determine the classification, the job scheduler accesses a database of node configurations. The job scheduler queries the database for the benchmarks for the node configurations. The job scheduler then determines if the performance measurement results for each node are within a certain range of the benchmarks. A node that falls outside the range of the node's benchmark is classified as low performing. A node that is within the range of the node's benchmark is classified as adequate. For example, a low performing node may be defined as a node that has a performance measurement result value that is ninety percent of the benchmark value. Thus, if a node is eighty-nine percent of the benchmark value, it is classified as low performing. Block 206 also begins a loop in which the job scheduler measures the performance of newly available nodes if the job scheduler determines there are not enough adequate nodes at block 208. After classifying the nodes as either low performing or adequate, control flows to block 208.

At block 208, the job scheduler determines if there are enough available nodes classified as adequate to service the request. The job scheduler determines this by comparing the number of nodes classified as adequate and available to the number of nodes requested by the application. If the job scheduler determines there are enough available nodes classified as adequate, control flows to block 214. If the job scheduler determines there are not enough available nodes classified as adequate, control then flows to block 210.

At block 210, the job scheduler waits for an unavailable node to become available. Nodes can become available for various reasons, just as they can become unavailable for various reasons. For example, if all jobs of a second application complete, the nodes assigned to the second application become available. A node down for maintenance or marked as low performing may be repaired and made available again. During this period, the job scheduler may be servicing other requests or performing other actions, but waits to perform any further operations with the current request. When another node becomes available, control then flows to block 212.

At block 212, the job scheduler issues a performance measurement command to the newly available node. This operation is similar to the operation performed at block 204. If multiple nodes become available, such as when a second application finishes, the job scheduler can issue performance measurement commands to all newly available nodes. Control then flows back to block 204.

Control flowed to block 214 if the job scheduler determined there are enough available nodes classified as adequate at block 208. At block 214, the job scheduler selects and assigns available nodes to the requesting application. In a cluster that consists of heterogeneous nodes, all nodes that do not meet the performance criteria requested by the requesting application are excluded at block 202. In all clusters, available nodes are classified as adequate or low performing at block 206. Thus, any node in the set of available, adequate nodes is eligible to be selected for assignment to the requesting application. If the number of nodes eligible for selection is greater than the number of requested nodes, the job scheduler can use various methods to select from the eligible nodes. For example, the job scheduler may make a random selection or select nodes that are located in close proximity to each other to reduce communication time. After selecting from the eligible nodes, the job scheduler assigns the selected nodes to the application and notifies the application of the assignment. Control then flows to block 216.

At block 216, the job scheduler verifies that low performing nodes are actually low performing and marks them as low performing if verified. For various reasons, performance measurement software may not always return an accurate result. For example, a process may be slow to quit or the particular state of the computing system is such that it adversely impacts the performance measurement in a way that does not reflect the actual performance of the computing system. Thus, the job scheduler attempts to verify that a node reflecting low performance measurement results is actually low performing. The job scheduler can do this by running the same performance measuring software multiple times to see if the resulting performance measurement results are different. The job scheduler could also run more extensive benchmarks that can provide more accurate results but may take a longer amount of time. The job scheduler then marks all nodes that are verified to be low performing as low performing. By marking them as low performing, the job scheduler makes the nodes unavailable.

The concept of employing abbreviated performance measurements to ensure the performance of a computing system can also be employed in cloud computing. Cloud computing can be used in a manner similar to a cluster, in that an application can request the assignment of one or more “virtual servers” from a cloud computing provider. To an application, a virtual server appears as an individual node, but can actually be one of multiple virtual servers hosted on a single node.

Virtual servers can be designed to emulate nodes with certain specifications, such that a virtual server is defined as having a particular set of processors running at a particular speed, a particular amount of memory, etc. Virtual servers can also be defined in more abstract terms, such as having a certain performance level or being designed to run certain applications.

But even when a virtual server is defined as having a certain specification, it may be difficult for a user to know if the performance they will receive from a particular virtual server is the same as a real node with the same specification. For example, if a user rents the use of a single virtual server from a cloud computing provider that has two virtual servers per server, the user may not know if the other virtual server is being used or not. The performance of the virtual server rented by the user will likely be lower if the other virtual server is being heavily used. Furthermore, many cloud computing solutions bill users for the time a virtual server is used. Thus, being aware of the difference in performance between multiple virtual servers can equate to a lower cost to the user. In other words, if a user can select from a set of virtual servers, test each one, and select the ones with the highest performance, the total cost the user incurs may be lower.

Although cloud computing environments can function as clusters, they generally have a wider applicability than a cluster. For example, most applications that run within a cluster environment will utilize multiple nodes, whereas many applications within a cloud environment may utilize one node. An example of an application that can take advantage of the features of a cloud computing environment is a web server. The hardware for a web server can be chosen by estimating the amount of traffic it will receive. The hardware is then chosen to handle at least the highest expected amount of traffic. Scenarios can occur in which traffic suddenly increases to a point that was unexpected, or was such a remote possibility that the added cost to cover the rare scenario was deemed not worth the investment. In a traditional hosting environment, scenarios such as this can be difficult to handle because of the difficulty in upgrading the server hardware. In a cloud environment, on the other hand, a new virtual server with greater performance can be provisioned quickly, and the web server migrated to the new virtual server with less trouble than upgrading physical software. As discussed above, the possibility exists that provisioning a new virtual server with greater performance on paper may not actually translate to greater real world performance. When attempting to recover from an unexpected increase in traffic to a web server, paying more for an upgraded virtual server that actually has similar performance not only costs more, but fails to solve the problem. Thus, being able to ensure the performance of a virtual server prior to provisioning it can prevent problems.

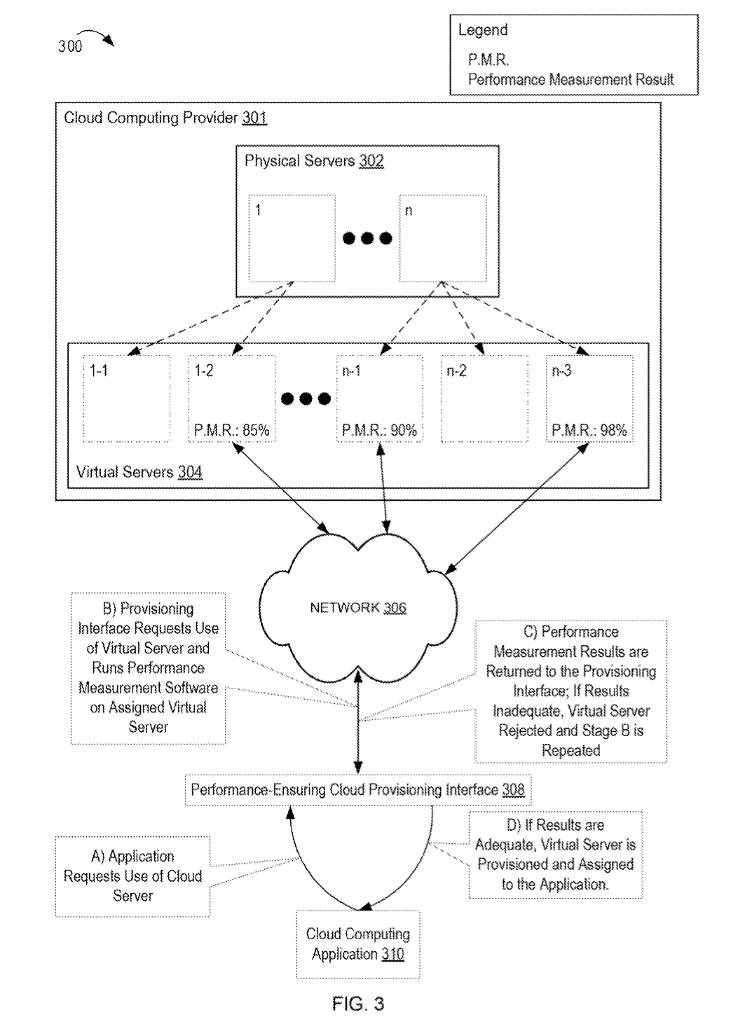

FIG. 3 depicts the interactions between components of a cloud computing environment to provision a virtual server with adequate performance. FIG. 3 depicts a cloud computing environment 300, including a cloud computing provider 301, a network 306, a performance-ensuring cloud provisioning interface (provisioning interface) 308, and a cloud computing application (application) 310. The cloud computing provider 301 includes a set of n physical servers (nodes) 302 and a set of virtual servers 304. The set of virtual servers 304 are hosted on the nodes 302. Each node in the set of nodes 302 can host a variable number of virtual servers 304. In this example, node 1 hosts two virtual servers 1-1 and 1-2, while node n hosts three virtual servers, n-1, n-2, and n-3. The network can be any network, including the Internet. The application 310 can be any application that can run on a cloud server, such as a web server, web application or high performance parallel processing application.

At stage A, the application 310 requests the use of a cloud server from the provisioning interface 308. The term “cloud server” refers to server resource provided by a cloud computing provider. A server resource may be a virtual server or a physical server. The term “cloud server” is used because a requestor or consumer of the server resource most likely has no visibility of whether the server resource is physical or virtual. In this example, the cloud computing provider 301 provides virtual servers 304. The term “cloud server” will be used for generic references, whereas “virtual server” will be used when referencing the specific illustrated implementation. Many scenarios can lead to an application requesting a cloud server. For example, an application that is designed to run on a cloud server can request a cloud server when the application is initially started. A web or other server may request a second or higher performing cloud server when the capacity of the current host cloud server is exceeded. Or, a high performance parallel application, as discussed above, can request cloud servers to run a set of jobs on.

In some implementations, the provisioning interface 308 can be designed to work with a specific type of application. In these implementations, the request between the application 310 and provisioning interface 308 can contain minimal information. Other implementations can use a generic provisioning interface 308, such that the request between the application 310 and provisioning interface 308 includes information detailing the performance specifications of an appropriate cloud server, such as described in stage A of FIG. 1. The provisioning interface 308 can also be implemented as various types of software. For example, the provisioning interface 308 can be an integral component of the application 310 or can implemented as a separate application or server process located on the same computing system as the application 310. The provisioning interface 308 can also be implemented as an application on a computing system other than the one the application 310 is located on. In implementations in which the provisioning interface 308 is located on a computing system other than the one the application 310 is located on, the application 310 can invoke the provisioning interface 308 by communicating with it over a network connection, such as with an application programming interface (API).

At stage B, the provisioning interface 308 requests the use of a cloud server from the cloud computing provider 301. The provisioning interface 308 sends the request through the network 306 to the cloud computing provider 301. The cloud computing provider 301 can classify the virtual servers 304 in various ways, such as ranking them based on performance or providing the specification in terms of hardware the virtual server performs comparably to. Thus, the request from the provisioning interface 308 can include information about the type of cloud server wanted.

The cloud computing provider 301 responds by assigning a cloud server from the set of virtual servers 304 that meets the request from the provisioning interface 308. Some virtual servers in the set of virtual servers 304, such as 1-1 and n-2 may be unavailable because they do not meet the specifications of the request or are already in use by another client. The cloud computing provider 301 selects a virtual server from the set of virtual servers 304 that meets the request specifications and is available. The cloud computing provider 301 sends the information for the selected virtual server to the provisioning interface 308. In this example, the first virtual server assigned to the provisioning interface 308 is 1-2.

After receiving the response from the cloud computing provider 301, the provisioning interface 308 loads performance measuring software onto the assigned virtual server. This performance measuring software can be similar or identical to the performance measuring software used by individual nodes discussed with FIG. 1. Many of the performance measurements used will be the same and abbreviated performance measurements are used for the same reasons. Because cloud computing generally has broader applicability than clusters, different performance measurements may be used in conjunction with the performance measurements used with cluster nodes. For example, testing the networking performance of the cloud server for use by a web server may be of increased importance compared to testing the networking performance of a node in a cluster. After loading the performance measuring software onto the virtual server, the provisioning interface 308 runs the performance measuring software.

At stage C, the performance measuring software returns the performance measurement results to the provisioning interface 308. After receiving the performance measurement results, the provisioning interface 308 determines whether the performance measurement results are sufficient for the application 310, based on the design of the provisioning interface 308 or information provided in the request from the application 310. If the resulting performance measurement results are inadequate, the virtual server is rejected and the provisioning interface 308 repeats stage B, provisioning another virtual server and testing it. In this example, a low performing server is any server that has performance measurement results less than ninety-five percent of the requested benchmarks/performance levels. Virtual server 1-2 is tested and performs at eighty-five percent of the requested benchmark, and is rejected. The provisioning interface 308 requests another virtual server, and is assigned n-1. Virtual server n-1 is tested, and performs at ninety percent of the requested benchmark, and is rejected. Finally, virtual server n-3 is tested, performing at ninety-eight percent of the requested benchmark, and is accepted.

At stage D, the results of the tests on virtual server n-3 are satisfactory, and virtual server n-3 is accepted by the provisioning interface 308. After accepting the virtual server, the provisioning interface 308 assigns the virtual server to the application 310 and notifies the application 310 of the assignment. The application 310 can now use the assigned virtual server.

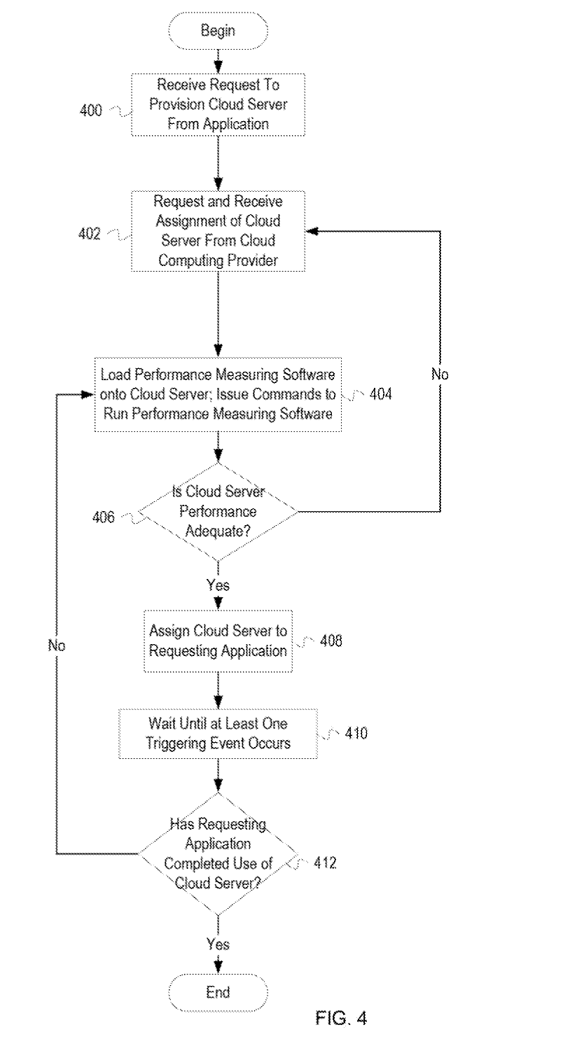

FIG. 4 depicts a flowchart of example operations to ensure the performance of a server in a cloud computing environment. As an example flowchart, FIG. 4 presents operations in an example order from which embodiments can deviate (e.g., operations can be performed in a different order than illustrated and/or in parallel). Control is discussed in reference to the provisioning interface.

At block 400, the provisioning interface receives a request from an application to provision a cloud server. As discussed above, the information included in the request can vary depending on the implementation. For example, in some implementations, the provisioning interface will be designed to respond to one particular type of request or work with one particular type of application. In these implementations, the application may provide the provisioning interface with minimal information. In implementations with more flexibility, the request to the provisioning interface can include more information, such as what the specifications of the server should be. After the provisioning interface receives the request from the application, control then flows to block 402.

At block 402, the provisioning interface requests the assignment of a cloud server from a cloud computing provider. The manner in which the provisioning interface requests the assignment of a cloud server will vary based on the implementation of the cloud computing provider. For example, the provisioning interface may request the use of a particular level of cloud server, where the performance capabilities of the cloud server vary based on the level. For other cloud computing providers, the provisioning interface may request a cloud server by specifying the hardware characteristics of a preferred cloud server. The provisioning interface then receives the assignment of a cloud server from the cloud computing provider. Block 402 also begins an optional loop. Control may flow back to block 402 if an assigned cloud server does not meet the expected performance or if performance of the cloud server degrades. This loop can continue until a cloud server with adequate performance is assigned. After requesting the assignment of a cloud server from the cloud computing provider, control then flows to block 404.

At block 404, the provisioning interfaces loads performance measuring software onto the cloud server and issues appropriate commands to run the performance measuring software. As discussed above, the performance measuring software can be similar to the performance measuring software used on nodes in a cluster. Other performance measuring software or tests specific to cloud computing environments can also be used. Block 404 also begins an optional loop. The provisioning interface can measure the performance of the cloud server at later times, and thus control can flow back to block 404 at the appropriate time(s). If control flows back to block 404, the performance measuring software is not reloaded onto the cloud server unless the performance measuring software is no longer on the cloud server, or if a new cloud server is being used. After the provisioning interface loads the performance measuring software onto the cloud server and issues appropriate commands to run the performance measuring software, control then flows to block 406.

At block 406, the provisioning interface determines whether the assigned cloud server has adequate performance. As with a cluster, the provisioning interface can determine whether a cloud server has adequate performance by comparing the results of the performance tests with benchmarks. The benchmarks may be predetermined, determined dynamically by the provisioning interface, or specified by the application. A score may be computed based on a variety of factors, as discussed above. If the provisioning interface determines that the assigned cloud server has adequate performance, control then flows to block 408. If the provisioning interface determines that the assigned cloud server does not have adequate performance, control then flows back to block 402.

At block 408, the provisioning interface assigns the cloud server to the requesting application. Because the performance of the cloud server has been verified, the requesting application can be assured that the cloud server will meet the application's specifications. Control then flows to block 410.

At block 410, the provisioning interface waits for at least one triggering event to occur. For example, the triggering event can be the passage of a certain amount of time or an indication from the requesting application that a job has completed. Additionally, the provisioning interface may wait for a combination of events. The specific events the provisioning interface waits for can vary between implementations. Once a triggering event has occurred, control then flows to block 412.

At block 412, the provisioning interface determines whether the requesting application has completed use of the cloud server. If the requesting application has not completed use of the cloud server, the provisioning interface can again measure the performance of the cloud server to determine whether the cloud server is still performing adequately. In scenarios where the requesting application runs a series of individual jobs, a triggering event at block 410 can be the completion of a job or at specified intervals, such as when the job awaits results from another job on another node. The provisioning interface can then measure the performance of the cloud server again before indicating to the application that the application can run the next job. In scenarios where the requesting application runs constantly, the provisioning interface can notify the application to pause the work being done on the cloud server until notified it can continue. If the provisioning interface determines that the application has completed use of the cloud server, the process ends. If the provisioning interface determines that the application has not completed use of the cloud server, control then flows back to block 404.

In some scenarios, such as web servers, the application may not be able to stop using a particular cloud server to verify the server performance. The provisioning interface can track various statistics about the cloud server, such as CPU usage or the amount of time elapsed before the cloud server responds to a request. If the statistics indicate that the performance of the cloud server has degraded, the provisioning interface can request the assignment of a new cloud server. After receiving a new cloud server, the provisioning interface ensures that the new cloud server has adequate performance as described above, then migrates the application to the new cloud server. The provisioning interface can then verify the performance of the old cloud server or release it and continue using the new cloud server. The tracking of statistics about a cloud server can be used as triggering events for performance verification, as discussed above.

As described above, a cloud computing environment can be used in a manner similar to a cluster, where jobs are distributed among any number of different computing systems. The migration of a job or application applies to these scenarios as well. Furthermore, jobs can be migrated similarly between nodes in clusters. The specific implementations will vary. For example, a provisioning interface for a cloud computing environment can provision a set of cloud servers and assign them to an application. The provisioning interface can provide information about the cloud servers sufficient to allow the requesting application to interface with the cloud servers directly. In such an implementation, the requesting application can include functionality that allows the provisioning interface to notify the requesting application that a cloud server is performing inadequately, or otherwise is to be replaced. The requesting application can, in response, pause or quit the job, notify the provisioning interface and wait for the information for a new cloud server. In other implementations, a provisioning interface can act as the interface with the cloud servers. In other words, the application would provide the job information to the provisioning interface, which would then run the jobs on the cloud servers. The provisioning interface would then pass the results back to the application. In these implementations, the provisioning interface would pass the job information to another cloud server if one began performing inadequately. Clusters can be implemented similarly, and both cloud computing environments and clusters can be implemented in other ways. Embodiments in which at least some jobs use results from other jobs, such as that described above with clusters, are also implemented similarly.

As previously mentioned, the embodiments described above do not limit the inventive subject matter, and are merely provided for exemplary purposes. For example, although discussed individually, embodiments relating to high performance computing clusters also apply to cloud computing environments, and vice versa. Thus, a node in a cluster and an individual cloud server in a cloud computing environment are interchangeable in the descriptions of embodiments and implementations. It also follows that the job scheduler and provisioning interface are interchangeable. Furthermore, the inventive subject matter is applicable to other areas where determining the performance of a computing system prior to running an application can reduce the cost or duration the application runs for.

Generally, abbreviated performance measuring software is designed to complete in seconds while still eliciting a key performance characteristic of each node. Thus, the actual runtime for a set of performance measurements will depend on now many performance measurements are taken. Additionally, the amount of time to run the performance measurement software can vary based on the performance of the computing system the performance measurement software is run on. For example, it typically takes longer to run performance measurement software on a computing system with lower performance. Two examples of abbreviated performance measurement software include the STREAM benchmarking software and the double-precision general matrix multiply (hereinafter DGEMM) subroutine. The former is designed to test memory bandwidth, while the latter is useful for floating point performance. Beyond existing performance measurement software, other abbreviated performance measurements can be designed to determine whether a node has a certain performance characteristic.

As discussed above, a score can be generated to describe the performance characteristics of a node. Whether to use a score or not can vary between implementations. For example, if one particular benchmark is the most important to a particular application, such as memory throughput, using only the memory throughput benchmark to determine a low performing node may be sufficient. If no individual benchmark is the most important, making the general performance characteristics of the node the most relevant, the use of a score may produce better results than using individual benchmarks.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

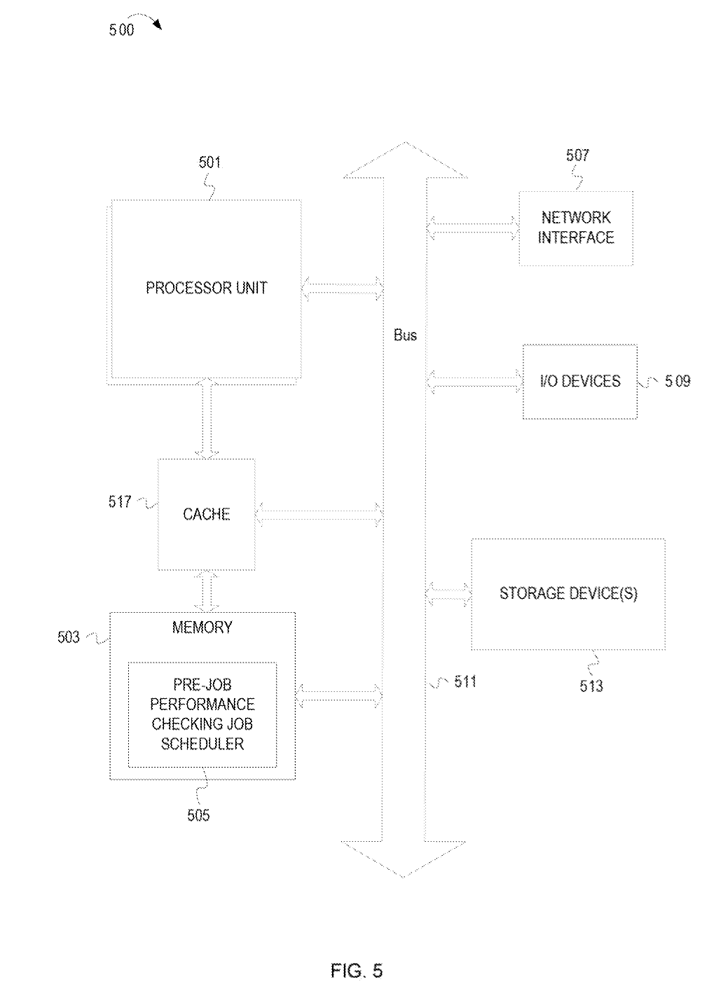

FIG. 5 depicts an example computing system with a pre-job performance measuring job scheduler. A computing system includes a processor unit 501 (possibly including multiple processors, multiple cores, multiple nodes, and/or implementing multi-threading, etc.). The computing system includes memory 503. The memory includes a pre-job performance measuring job scheduler (job scheduler) 505. The memory 503 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 511 (e.g., PCI, ISA, PCI-Express, HyperTransport® bus, InfiniBand® bus, NuBus bus, etc.), I/O devices 509 (e.g., keyboard, mouse, monitor, microphone, speaker, etc.), a network interface 507 (e.g., an ATM interface, an Ethernet interface, a Frame Relay interface, SONET interface, wireless interface, etc.), a cache 517 (e.g., a direct mapped cache, a 2-way set associative cache, a fully associative cache, etc.) and a storage device(s) 513 (e.g., optical storage, magnetic storage, etc.). The cache 517 may be a lower level cache (e.g., L1 cache embodied in a processor) or a higher level cache (e.g., L2 cache, L3 cache, etc.). The job scheduler 505 embodies functionality to implement embodiments described above. The job scheduler 505 functions as described above, selecting available nodes or equivalent and running performance tests on at least the selected nodes. The job scheduler 505 then assigns adequate nodes to a requesting application. Although the job scheduler 505 is depicted as residing in the memory 503, any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, storage device(s) 513, network interface 507, cache 517, and I/O devices 509 are coupled to the bus 511. Although illustrated as being coupled to the bus 511, the memory 503 may be coupled to the processor unit 501.

While the embodiments are described with reference to various implementations and exploitations, it will be understood that these embodiments are illustrative and that the scope of the inventive subject matter is not limited to them. In general, techniques for high performance and cloud computing as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
issuing a command to run abbreviated measurements of performance for one or more computing nodes to determine whether a number of the one or more computing nodes is adequate to perform a computing job, wherein a request for the computing job indicates the number;
assigning the computing job to a set of the number of computing nodes if each of the set of the number of computing nodes is adequate to perform the computing job according to performance measurement results of the abbreviated measurements; and
for any of the one or more of computing nodes that is inadequate to perform the computing job according to performance measurement results of the abbreviated measurements, indicating those computing nodes as low performing.

2. The method of claim 1, wherein said issuing the command to run the abbreviated measurements of performance of the one or more computing nodes is responsive to receiving one of a request from an application for the use of at least one of the one or more computing nodes, an indication that a computing job on the first computing node has completed, an indication that the first computing node may be low performing, and an indication of a passage of time.

3. The method of claim 2, wherein the request from the application for use of at least one of the one or more computing nodes indicates at least one of a minimum number of computing nodes, a maximum number of computing nodes, computing node configuration information, computing node identification information, and computing node performance characteristics.

4. The method of claim 3, wherein the performance characteristics comprise a set of performance measurements, wherein each performance measurement in the set of performance measurements is associated with a value indicating one of a weight and an order.

5. The method of claim 1, wherein a computing node comprises a cloud server, wherein a cloud server comprises one of a virtual server and a physical server.

6. The method of claim 1 further comprising:
sending a request to use one or more computing nodes; and
receiving a response identifying the one or more computing nodes.

7. The method of claim 1, wherein indicating those computing nodes as low performing comprises:
rejecting at least one of the one or more computing nodes.

8. The method of claim 1, further comprising:
issuing a command to halt a computing job running on a second computing node of the one or more computing nodes;
issuing a command to run abbreviated measurements of performance of the second computing node; and
continuing the computing job depending upon the run of the abbreviated measurements of performance of the second computing node.

9. The method of claim 8, wherein continuing the computing job depending upon the run of the abbreviated measurements of performance comprises:
responsive to the results of the abbreviated measurements of performance indicating that the second computing node is not adequate to perform the job, migrating the job to a third computing node of the one or more computing nodes; and
responsive to the results of the abbreviated measurements of performance indicating that the second computing node is adequate to perform the job, continuing the computing job on the second computing node.

10. The method of claim 1, further comprising:
assigning a score to any of the one or more computing nodes, wherein the score comprises the performance measurement results; wherein the performance measurement results are one of unweighted, weighted and ranked.

11. A computer program product comprising:
a computer readable storage medium having computer usable program code embodied therewith, the computer usable program code comprising a computer usable program code configured to:
issue a command to run abbreviated measurements of performance for one or more computing nodes to determine whether a number of the one or more computing node is adequate to perform a computing job, wherein a request for the computing job indicates the number;
assign the computing job to a set of the number of computing nodes if each of the set of the number of computing nodes is adequate to perform the computing job according to performance measurement results of the abbreviated measurements; and
for any of the one or more computing nodes that is inadequate to perform the computing job according to performance measurement results of the abbreviated measurements, indicate those computing nodes as low performing.

12. The computer program product of claim 11, wherein the computer usable program code is further configured to:
send a request to use one or more computing nodes; and
receive a response identifying the one or more computing nodes.

13. The computer program product of claim 11, wherein the computer usable program code configured to indicate those computing nodes as low performing is configured to:
reject at least one of the one or more computing nodes.

14. The computer program product of claim 11, wherein the computer usable program code is further configured to:
issue a command to halt a computing job running on a second computing node of the one or more computing nodes;
issue a command to run abbreviated measurements of performance of the second computing node; and
continue the computing job depending upon the run of the abbreviated measurements of performance of the second computing node.

15. The computer program product of claim 14, wherein the computer usable program code configured to continue the computing job depending upon the run of the abbreviated measurements of performance of the second computing node is configured to:
responsive to the results of the abbreviated measurements of performance indicating that the second computing node is not adequate to perform the job, migrate the job to a third computing node of the one or more computing nodes; and
responsive to the results of the abbreviated measurements of performance indicating that the second computing node is adequate to perform the job, continue the computing job on the second computing node.

16. The computer program product of claim 11, wherein the computer usable program code is further configured to:
assign a score to any of the one or more computing nodes, wherein the score comprises the performance measurement results; wherein the performance measurement results are one of unweighted, weighted and ranked.

17. A system comprising:
a plurality of computing systems, wherein each computing system in the plurality of computing systems comprises:
memory;
a network interface; and
a processor coupled with the memory and the network interface;
wherein at least one computing system in the plurality of computing systems is configured to:
issue a command to run abbreviated measurements of performance for one or more computing nodes to determine whether a number of the one or more computing node is adequate to perform a computing job, wherein a request for the computing job indicates the number;
assign the computing job to a set of the number of computing nodes if each of the set of the number of computing nodes is adequate to perform the computing job according to performance measurement results of the abbreviated measurements; and
for any of the one or more computing nodes that is inadequate to perform the computing job according to performance measurement results of the abbreviated measurements, indicate those computing nodes as low performing.

18. The system of claim 17, wherein the at least one computing system in the plurality of computing systems is further configured to:
send a request to use one or more computing nodes; and
receive a response identifying the one or more computing nodes.

19. The system of claim 17, wherein the at least one computing system in the plurality of computing systems is further configured to:
issue a command to halt a computing job running on a second computing node of the one or more computing nodes;
issue a command to run abbreviated measurements of performance of the second computing node; and
continue the computing job depending upon the run of the abbreviated measurements of performance of the second computing node.

20. The system of claim 19, wherein the at least one computing system in the plurality of computing systems configured to continue the computing job depending upon the run of the abbreviated measurements of performance of the second computing node is further configured to:
responsive to the results of the abbreviated measurements of performance indicating that the second computing node is not adequate to perform the job, migrate the job to a third computing node of the one or more computing nodes; and
responsive to the results of the abbreviated measurements of performance indicating that the second computing node is adequate to perform the job, continue the computing job on the second computing node.
